(19) United States
(12) Patent Application Publication
(10) Pub. No.: US 2025/0200441 A1
(43) Pub. Date: Jun. 19, 2025

(54) LARGE LANGUAGE MODEL FOR AUTOMATED PRIOR AUTHORIZATION

(71) Applicant: Express Scripts Strategic Development, Inc., St. Louis, MO (US)

(72) Inventors: Pritesh J. Shah, Paramus, NJ (US); Brandon J. Griesel, St. Louis, MO (US); Christopher R. Markson, Hawthorne, NJ (US)

(21) Appl. No.: 18/981,484

(22) Filed: Dec. 14, 2024

Related U.S. Application Data
(60) Provisional application No. 63/610,906, filed on Dec. 15, 2023.

(51) Int. Cl. G06N 20/00

(52) U.S. Cl. CPC G06N 20/00

(57) ABSTRACT

A method for adapting a user interface includes accessing a data package. The method includes determining whether execution of an action based on the data package requires secondary authorization. The method includes, in response to a determination that the execution requires secondary authorization, identifying a set of inquiries and determining whether user data includes information associated with the set of inquiries. The method includes, in response to a determination that the user data includes information associated with the set of inquiries, determining a set of responses. The method includes transmitting a request for secondary authorization including the set of responses and a first subset of the user data. The set of responses is based on the first subset of the user data. The method includes transforming the user interface to display the set of responses, the set of inquiries, and the first subset of the user data.

### CROSS-REFERENCE TO RELATED APPLICATIONS

This application claims the benefit of U.S. Provisional Application No. 63/610,906 filed Dec. 15, 2023 (Attorney Docket No. ESRX-457PRV), the entire disclosure of which is incorporated by reference. The entire disclosure of the following application is incorporated by reference: U.S. Provisional Application No. 63/720,625 filed Nov. 14, 2024 (Attorney Docket No. ESRX-472PV2).

### FIELD

The present disclosure relates to data processing via machine learning models, and more particularly to generating predictions.

### BACKGROUND

Many data packages contain executable actions that require authorization before they can be executed. Authorization documentation is not standardized and essential information is frequently mixed with extraneous data across many pages and/or files. A solution is required to simplify the authorization documentation review process.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method for adapting a user interface includes accessing a data package. The data package specifies an object. The method includes determining whether execution of an action based on the data package requires secondary authorization. The method includes, in response to a determination that the execution requires secondary authorization, identifying a set of inquiries associated with the object. The method includes, in response to a determination that the execution requires secondary authorization, determining, via a machine learning model, whether user data includes information associated with the set of inquiries. The method includes, in response to a determination that the user data includes information associated with the set of inquiries, determining, via the machine learning model, a set of responses to the set of inquiries using the user data. The method includes, in response to a determination that the execution requires secondary authorization, transmitting a request for secondary authorization including the set of responses and a first subset of the user data. The set of responses is based on the first subset of the user data. The method includes transforming the user interface to display the set of responses, the set of inquiries, and the first subset of the user data.

In other features, identifying the set of inquiries includes accessing a database including an association between different sets of inquiries and different types of object data packages. In other features, identifying the set of inquiries includes identifying the data package in the database. In other features, identifying the set of inquiries includes retrieving an expected set of inquiries from the database that is associated with the object.

In other features, identifying the set of inquiries includes receiving the set of inquiries. In other features, the set of inquiries is a subset of the expected set of inquiries. In other features, the method includes receiving a communication that carries the data package.

In other features, the method includes, in response to a determination that the user data does not include information associated with the set of inquiries, generating a prompt to obtain additional data corresponding to at least one inquiries of the set of inquiries. In other features, the method includes determining the set of responses using the additional data.

In other features, the user data includes an electronic medical record associated with a user. The user is associated with the data package for the object. In other features, the user data includes past medical prescription information of the user. In other features, the user data includes past medical claims of the user. In other features, the user data includes past communications exchanged between the user and one or more secondary users.

In other features, the method includes receiving a secondary authorization decision. In other features, the method includes receiving a first inquiry in a first format. In other features, the method includes determining, via the machine learning model, that the first inquiry corresponds to a first type of user data. In other features, the method includes, in response to a determination that the first inquiry corresponds to the first type of user data, generating, via the machine learning model, a first response including a first portion of the user data.

In other features, the method includes receiving a second inquiry in a second format. In other features, the method includes determining, via the machine learning model, that the second inquiry corresponds to the first type of user data. In other features, the method includes in response to a determination that the second inquiry corresponds to the first type of user data, generating, via the machine learning model, a second response including the first portion of the user data.

In other features, the method includes training the machine learning model by performing training operations including obtaining a batch of training data including a first collection of prior authorization responses associated with a first set of ground truth decisions. In other features, the method includes training the machine learning model by performing training operations including processing the first collection of prior authorization responses by the machine learning model to generate an estimated set of decisions. In other features, the method includes training the machine learning model by performing training operations including computing a loss based on a deviation between the estimated set of decisions and the first set of ground truth decisions. In other features, the method includes training the machine learning model by performing training operations including updating one or more parameters of the machine learning model based on the computed loss.

In other features, the method includes transmitting the user data to the machine learning model in a set of segments. In other features, the method includes determining whether a size of the user data exceeds a size threshold. In other features, the method includes, in response to a determination that the size of the user data exceeds a size threshold, separating the user data into the set of segments.

In other features, the method includes detecting, using natural language processing, a new language entity. In other features, the method includes generating a first segment of the set of segments that includes data within a proximity limit of the new language entity.

In other features, the method includes determining whether a second subset of user data of the user data meets a similarity threshold to one or more inquiries of the set of inquiries. In other features, the method includes, in response to a determination that the second subset of user data meets the similarity threshold, generating a second segment of the set of segments that includes the second subset of user data.

In other features, determining whether the user data is associated with the set of inquiries includes determining whether a portion of the user data is current by determining whether the user data describes that the portion is current. In other features, determining whether the user data is associated with the set of inquiries includes determining whether a portion of the user data is current by inferring whether the user data is current based on a date associated with a source of the portion or one or more dates associated with the portion. In other features, the method includes transforming the user interface to display a set of sources associated with the first subset of the user data. In other features, the method includes extracting, by the machine learning model, a set of raw data from the user data.

A system includes memory hardware configured to store processor-executable instructions. The system includes processor hardware configured to execute the instructions stored by the memory hardware. The instructions include accessing a communication including a data package for an object. The instructions include determining whether the data package requires secondary authorization. The instructions include, in response to a determination that the data package requires secondary authorization, identifying a set of inquiries associated with the object. The instructions include, in response to a determination that the data package requires secondary authorization, determining, via a machine learning model, whether user data includes information associated with the set of inquiries. The instructions include, in response to a determination that the user data includes information associated with the set of inquiries, determining, via the machine learning model, a set of responses to the set of inquiries using the user data. The instructions include, in response to a determination that the data package requires secondary authorization, transmitting a request for secondary authorization including the set of responses and a first subset of the user data. The set of responses is based on the first subset of the user data. The instructions include, transforming a user interface to display the set of responses, the set of inquiries, and the first subset of the user data.

In other features, identifying the set of inquiries includes accessing a database including an association between different sets of inquiries and different types of object data packages. In other features, identifying the set of inquiries includes identifying the data package in the database. In other features, identifying the set of inquiries includes retrieving an expected set of inquiries from the database that is associated with the object.

A non-transitory computer readable medium includes non-transitory computer-readable instructions including accessing a communication including a data package for an object. The instructions include determining whether the data package requires secondary authorization. The instructions include, in response to a determination that the data package requires secondary authorization, identifying a set of inquiries associated with the object. The instructions include, in response to a determination that the data package requires secondary authorization, determining, via a machine learning model, whether user data includes information associated with the set of inquiries. The instructions include, in response to a determination that the user data includes information associated with the set of inquiries, determining, via the machine learning model, a set of responses to the set of inquiries using the user data. The instructions include, in response to a determination that the data package requires secondary authorization, transmitting a request for secondary authorization including the set of responses and a first subset of the user data. The set of responses is based on the first subset of the user data. The instructions include transforming a user interface to display the set of responses, the set of inquiries, and the first subset of the user data.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example patient management platform, according to some examples.

FIG. 2 is an example database that may be deployed within the system of FIG. 1, according to some examples.

FIG. 3 is a block diagram of an example patient management platform that may be deployed within the system of FIG. 1, according to some examples.

FIG. 4 is a block diagram of an example set of sequences that can be used to perform automated prior authorization, according to some examples.

FIG. 5 is an example set of inquiries, according to some examples.

FIGS. 6A-6B are a flowchart illustrating example operations of the patient management platform, according to some examples.

FIG. 7 is a block diagram illustrating an example software architecture, which may be used in conjunction with various hardware architectures herein described.

FIG. 8 is a block diagram illustrating components of a machine, according to some examples.

FIG. 9 is a functional block diagram of an example neural network with a single input layer.

FIG. 10 is a functional block diagram of an example neural network with a hidden layer.

FIG. 11 is a functional block diagram of an example neural network that can be used for the inference engine or other functions as described herein to produce a predictive model.

FIG. 12 is a functional block diagram of an example system including a high-volume pharmacy.

FIG. 13 is a functional block diagram of an example pharmacy fulfillment device, which may be deployed within the system of FIG. 12.

FIG. 14 is a functional block diagram of an example order processing device, which may be deployed within the system of FIG. 12.

In the drawings, reference numbers may be reused to identify similar and/or identical elements.

### DETAILED DESCRIPTION

### Introduction

Example methods and systems for a patient data management platform are provided. Specifically, the methods and systems automatically provide patient information for a secondary authorization (such as a prior authorization) request using one or more machine learning models. The secondary authorization can be an automated, machine authorization using electronic records. The methods and systems access a communication comprising an object, such as a medicinal drug prescription associated with a need for prior authorization from an entity, e.g., an entity electrical computing system. The methods and systems process, by a machine learning model, the communication to identify an expected set of inquiries corresponding to the prior authorization for the medicinal drug prescription. The methods and systems determine, by the machine learning model, a set of responses to the set of inquiries based on a set of patient information. The methods and systems provide a subset of the set of patient information to the entity in response to transmitting to the entity a request for the prior authorization for the medicinal drug prescription. In the following description, for purposes of explanation, numerous specific details are set forth in order to provide a thorough understanding of the examples. It will be evident, however, to one of ordinary skill in the art that examples of the disclosure may be practiced without these specific details.

A prescription, often abbreviated R or Rx, is a formal communication from a physician or other registered healthcare professional to a pharmacist, authorizing them to dispense a specific prescription drug for a specific patient. Sometimes, the prescriptions require prior authorization from a payor, insurance provider, or other system before the medication can be dispensed. The prior authorization can include a set of questions or inquiries. A pharmacist or other medical professional spends a great deal of time formulating responses to the questions or inquiries. For example, the pharmacist or other medical professional may need to contact the patient in order to obtain certain information. Sometimes this information is incomplete or inaccurate which can lead to rejections by the payor or insurance provider and can cause the patient to incur delays in obtaining the medication.

Technicians and pharmacist spend considerable amount of time to properly respond to the questions or inquiries associated with the prior authorization. This can also introduce manual errors which can have disastrous consequences in relation to filling the prescriptions. As a result, users are burdened with having to navigate multiple pages of information to look up the appropriate answers to the questions sought by the payors and repeatedly inputting such information. This wastes a great deal of time and resources that can be devoted to other tasks.

The disclosed techniques provide systems and methods to automate the prior authorization process. The disclosed techniques access a communication that includes a medicinal drug prescription associated with a need for prior authorization from an entity. The disclosed technique process, by one or more machine learning models, the communication to identify an expected set of inquiries corresponding to the prior authorization for the medicinal drug prescription. The disclosed technique search, by the machine learning model, a set of patient information associated with the set of inquiries and provide a subset of the set of patient information to the entity in response to transmitting to the entity a request for the prior authorization for the medicinal drug prescription.

As a result, a great deal of time and resources are saved and the user need not have to navigate through a multitude of pages of information to generate responses associated with prior authorizations. This saves time and reduces the amount of resources needed to accomplish a task.

### Example Management System

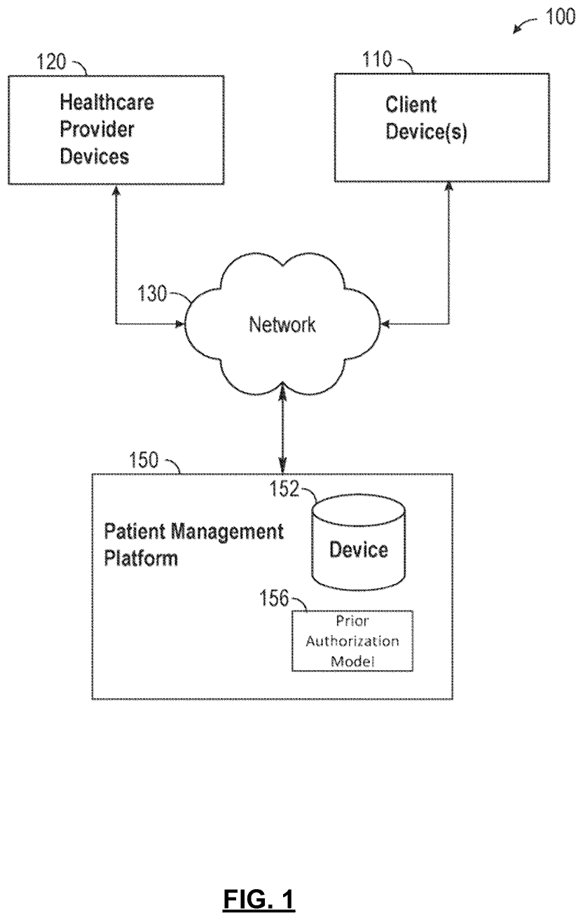

FIG. 1 is a block diagram showing an example patient management system 100, according to some examples. The patient management system 100 includes one or more client devices 110, one or more healthcare provider devices 120, and a patient management platform 150 that are communicatively coupled over a network 130 (e.g., Internet, telephony network).

As used herein, the term “client device” may refer to any machine that interfaces to a communications network (such as network 130) to access the patient management platform 150. The client device 110 may be, but is not limited to, a mobile phone, desktop computer, laptop, portable digital assistants (PDAs), smart phones, a wearable device (e.g., a smart watch), tablets, ultrabooks, netbooks, laptops, multi-processor systems, microprocessor-based or programmable consumer electronics, game consoles, set-top boxes, or any other communication device that a user may use to access a network or the patient management platform 150.

In some cases, the patient management platform 150 is accessible over a global communication system, e.g., the Internet or world wide web. In such instances, the patient management platform 150 hosts a website that is accessible to the client devices 110. Upon accessing the website, the client devices 110 provide secure login credentials, which are used to access a profile associated with the login credentials and one or more patient profiles or patient information. As used herein, patient information includes any medical information associated with a patient including one or more medicinal drug prescriptions, prior medical insurance claims that were approved or denied, one or more electronic health records or medical health records, patient health information, patient demographic information, prior bloodwork results, prior results of non-bloodwork tests, medical history, medical provider notes in the electronic health record, intake forms completed by the patient, patient in-network insurance coverage, patient out-of-network insurance coverage, patient location, and/or one or more treatment preferences. One or more user interfaces associated with the patient management platform 150 are provided over the Internet via the website to the client devices 110. The user interfaces may include set locations or fixed locations whereat it displays the patient data.

Healthcare provider devices 120 can include the same or similar functionality as client devices 110 for accessing the patient management platform 150. In some cases, the healthcare provider devices 120 are used by “internal” users. Internal users are medical professionals, such as medical personnel, physicians, healthcare professionals, clinicians, healthcare providers, health-related coaches pharmacy benefit manager (PBM) operators, pharmacists, specialty pharmacy operators or pharmacists, or the like that are associated with, certified by, or employed by one or more organizations that provides the patient management platform 150. In some cases, the healthcare provider devices 120 are used by “external” users.

The healthcare provider devices 120 are used to access the patient management platform 150 and view many records associated with many different patients (or users associated with client devices 110) and their respective patient information. Different levels of authorization can be associated with different users to control which records the users have access. In some instances, only records associated with those patients to which a given user is referred, are made accessible and available to the given user device. Sometimes, a first user can refer a patient or records associated with the patient to a second user. In such circumstances, the second user becomes automatically authorized to access and view the patient's records that were referred by the first user. The user interfaces on the healthcare provider devices 120 may include set locations or fixed locations whereat it displays the patient data.

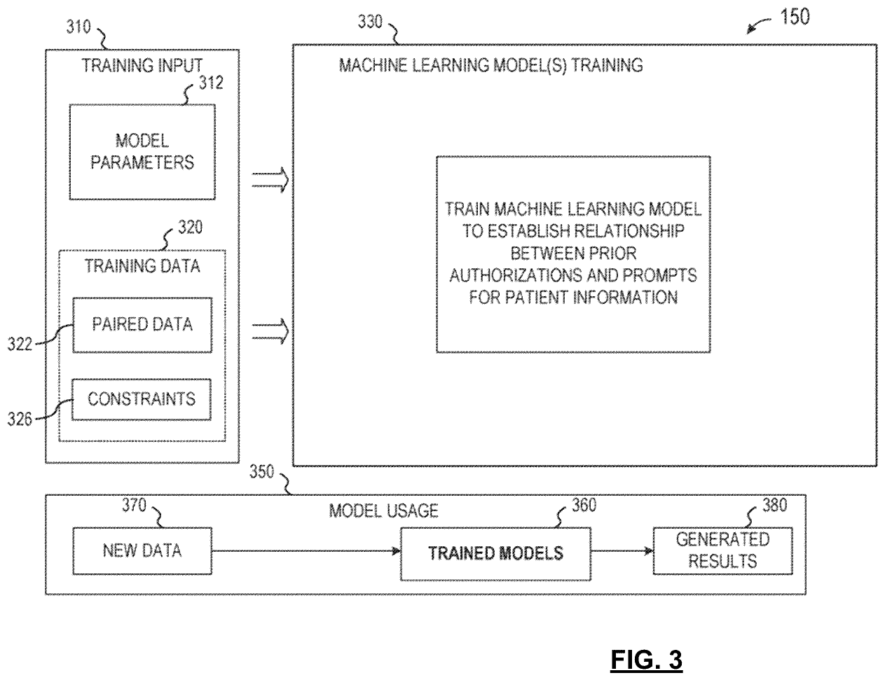

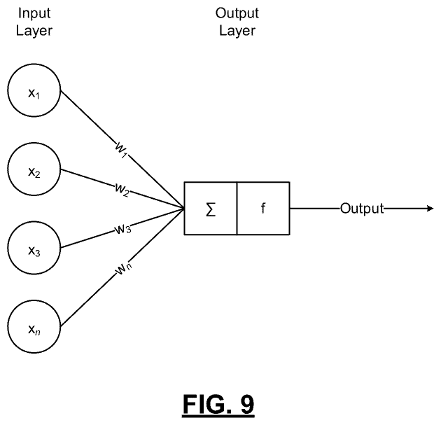

In some examples, the patient management platform 150 (and specifically the prescription entity model 154 and prior authorization model 156) can implement one or more machine learning models, such as one or more neural networks (discussed below in connection with FIGS. 3 and 9). The patient management platform 150 can use the machine learning models to simplify and expedite the management of patient information and particularly to generate or predict responses associated with prior authorizations for prescriptions. Particularly, the patient management platform 150 can be accessed by the healthcare provider devices 120.

A first one of the healthcare provider devices 120 of a healthcare professional can be used to navigate to a prescription page to write a prescription for a medicinal drug for a patient. The written prescription can then be delivered to or communicated to a second one of the healthcare provider devices 120. In some cases, the written prescription can be communicated to the second one of the healthcare provider devices 120 through one or more channels, such as a voice channel (where the written prescription is spoken verbally to a pharmacist associated with the second one of the healthcare provider devices 120); a facsimile (fax) transmission channel; an electronic prescription drug transmission channel, or a physical medium, such as hand delivery of a paper or document containing the prescription. The second one of the healthcare provider devices 120 can generate a document with text containing the prescription received from the first one of the healthcare provider devices 120.

The second one of the healthcare provider devices 120 can determine that, prior to dispensing the medication, prior authorization from a payor, insurance provider, or other third-party entity (generally referred to as an entity) is required or needed. For example, prior to dispensing the medication, certain medical information associated with the patient may first need to be verified and approved by the entity. In such cases, the second one of the healthcare provider devices 120 can provide the prescription to one or more machine learning models to automatically obtain and aggregate a set of patient information that is needed to properly respond to the prior authorization request.

Specifically, the patient management platform 150 can process or analyze the prescription using a machine learning model (e.g., an artificial neural network, such as a convolutional neural network) (e.g., the prior authorization model 156) to extract one or more features from the prescription. The one or more features can then be processed or analyzed by the machine learning model to generate or predict a set of prompts that identify medical information needed for responding to a prior authorization request from an entity. The set of prompts can then be processed by the machine learning model (e.g., a large language model (LLM)).

Generative artificial intelligence (AI) is a term that may refer to any type of artificial intelligence that can create new content from training data. For example, generative AI can produce text, images, video, audio, code or synthetic data that are similar to the original data but not identical. In some cases, generative AI can include or implement large language models (LLMs). The generative AI and/or LLMs receive a prompt (including instructions) along with a set of data to process based on the prompt. The generative AI and/or LLMs process the data in accordance with the instructions of the prompt and generate an output that includes modifications of the set of data based on prior knowledge of the generative AI and/or LLMs.

Some of the techniques that may be used in generative AI are:

Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.

Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis.

Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.

Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.

Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data that is output include trend assessment and predictions, translations, summaries, image or video recognition and categorization, natural language processing, face recognition, user sentiment assessments, advertisement targeting and optimization, voice recognition, or media content generation, recommendation, and personalization.

The machine learning model (or generative AI) can have access to a wide variety of patient information that is stored in the database 152. The machine learning model can process the wide variety of patient information and extract a portion of the patient information based on the set of prompts. In some implementations, the quantity of patient information may be compared to an input threshold of the machine learning model. For example, the input threshold may be a size limit for an individual file or document, or a total size limit (of all submitted inputs). In some implementations, the patient information is separated into segments (also called chunks) in response to the quantity of patient information exceeding the input threshold. In some implementations, all input information from a data source (such as a file or a group of files) is chunked and submitted. In some implementations, a section of information that is in proximity to an entity identified by natural language processing (NLP) is submitted. For example, the input information is analyzed via NLP, and a new chunk is created when a new entity is detected. In some implementations, the section of information submitted includes 10, 20, 30, or 50 characters or words around a detected entity. In some implementations, proximity is based additionally or alternatively on a spatial relationship, such as the number of pixels from the entity to other words or characters. In some implementations, the entities used to create chunks are selected and determined based on the set of prompts. In some implementations, cosine similarity is used to compare patient information to the set of prompts and only information (and surrounding information) that meets a similarity threshold is submitted to the machine learning model.

After collecting the portion of the patient information, the patient management platform 150 can communicate with the entity (e.g., a payor or insurance provider). The patient management platform 150 provides an identification of the prescription and can receive from the entity a form that includes a set of inquiries associated with the prior authorization. The patient management platform 150 can process the form that includes set of inquiries by the machine learning model (e.g., the LLM) to identify which set of patient information from the extract portion is needed to populate the set of inquiries and generate a response. The patient management platform 150 obtains the set of patient information and generates a response by populating the form and transmitting the populated form back to the entity.

In some implementations, an inquiry of the set of inquiries is analyzed to determine whether the inquiry has a specified set of enumerated responses. For example, the inquiry answers may include “yes,” “no,” and “maybe,” or “within the last week,” and “within the last year,” etc.). In some implementations, the patient management platform 150 may determine that not all of the inquiries of the set of inquiries need to be answered to determine a prior authorization decision. In some implementations, the patient management platform 150 determines that answering a first question renders a second and third question moot, but that a response to a fourth question must be provided to determine a prior authorization decision. For example, the patient management platform 150 determines that the inquiries include branching logic such as: “if yes, please answer question two; if no, please answer question 6.” Following the branching logic to completion is necessary to determine the prior authorization decision and/or prediction.

In some implementations, the branching logic of the set of inquiries is manually entered. In some implementations, the machine learning model processes the set of inquiries and determines the branching logic (in other words, which inquiries need to be answered based on the provided responses to determine the prior authorization decision).

In some cases, the patient management platform 150 determines that one or more inquiries in the form lack sufficient information in the portion of the patient information. In such cases, the patient management platform 150 can present a GUI to the clinician, such as on the second one of the healthcare provider devices 120. The GUI can include the prescription received from the first one of the healthcare provider devices 120, the form that has been at least partially populated by the machine learning model, and/or an identification visually of a portion of the form that needs to be manually populated. In response, the patient management platform 150 can receive input from the second one of the healthcare provider devices 120 indicating the data needed to populate the portion of the form for which information was missing or unable to be populated by the machine learning model.

The patient management platform 150 can then transmit the populated form back to the entity. The patient management platform 150 can receive a response from the entity indicating whether the prior authorization is approved or denied. Based on that response, the patient management platform 150 can dispense the medication to the patient.

In some examples, patient management platform 150 can implement a machine learning model that processes a set of responses to the prior authorization and predicts or estimates a decision (approval or denial) of the prior authorization based on the set of responses to a set of inquiries of the prior authorization. In such cases, the patient management platform 150 can receive the populated form generated automatically based on patient information. The patient management platform 150 applies a machine learning model to the responses on the populated form to predict whether the decision is approval or denial. Based on that decision, the patient management platform 150 can revise the responses on the form or transmit the populated form for approval by the external entity.

In some examples, the patient management platform 150 trains the prior authorization model 156 by performing training operations including obtaining a batch of training data that includes a first collection of prior authorization responses associated with a first set of ground truth decisions. The prior authorization model 156 processes the first prior authorization responses by the machine learning model to generate an estimated set of decisions and computes a loss based on a deviation between the estimated set of decisions and the first set of ground truth decisions. The prior authorization model 156 updating one or more parameters of the prior authorization model 156 based on the computed loss. The patient management platform 150 repeats these training operations for multiple batches of the training data and completes training of the prior authorization model 156 when a stopping condition/criterion is reached.

The network 130 may include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The healthcare provider devices 120 can be used to access pharmacy claims, medical data (e.g., medical information 230 stored in database 152), laboratory data and the like for one or more patients that the healthcare provider devices 120 are authorized to view. This patient information 210 can be maintained in a database 152 by the patient management platform 150 or in a third-party database accessible to the patient management platform 150 and/or the healthcare provider devices 120.

In some examples, the client devices 110 and the patient management platform 150 can be communicatively coupled via an audio call (e.g., VoIP, Public Switched Telephone Network, cellular communication network, etc.) or via electronic messages (e.g., online chat, instant messaging, text messaging, email, and the like). While FIG. 1 illustrates a single client device 110 and a single healthcare provider device 120, it is understood that a plurality of such devices can be included in the system 100 in other embodiments.

### Example Database

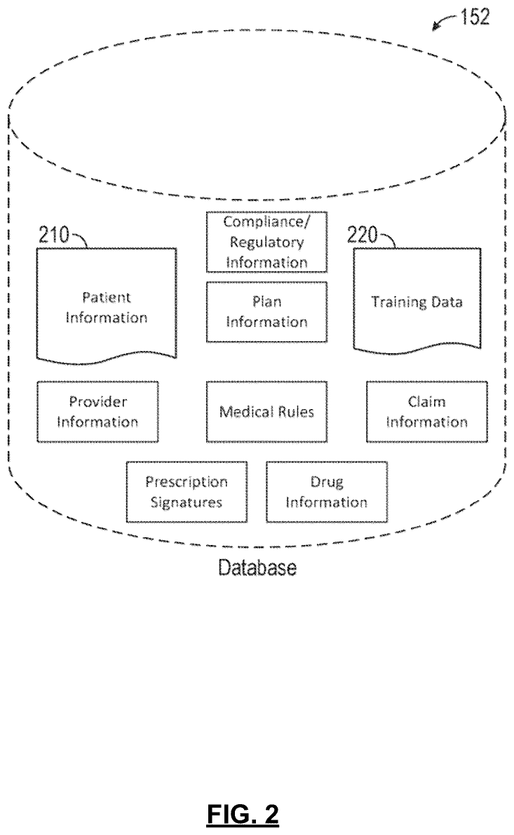

FIG. 2 is an example database 152 that may be deployed within the system of FIG. 1, according to some examples. The database 152 includes patient information 210 and training data 220. The patient information 210 can be generated or accessed by the patient management platform 150. For example, the patient management platform 150 can access one or more patient records from one or more sources, including pharmacy claims, benefit information, prescribing physician information, dispensing information (e.g., where and how the patient obtains their current medications), medicinal drug prescriptions, prescription signatures, demographic information, prescription information including dose quantity and interval, and input from a patient received via a user interface presented on the client device 110 and so forth. The patient management platform 150 can collect this information from the patient records and generates a patient features vector that includes this information.

In some examples, the training data 220 includes training sets including collections of drug prescriptions and corresponding prior authorizations (e.g., lists of inquiries or medical questions) associated with sets of ground truth prompts for different components of collections of medical information for a patient. The training data 220 is used to train the prior authorization model 156 implemented by patient management platform 150 to generate automatically responses to inquiries included in a form corresponding to a prior authorization.

In some examples, the patient management platform 150 and/or the healthcare provider devices 120 can be used to generate the training data 220. Specifically, the healthcare provider devices 120 and/or the patient management platform 150 can receive various medical prescriptions that were created by healthcare professionals along with corresponding prior authorizations. The healthcare provider devices 120 and/or the patient management platform 150 can receive labels (manually and/or automatically) for each component of each of the medical prescriptions that indicate the type of medical information needed to response to the prior authorization inquiry form. This labeled data can be used to train the prior authorization model 156.

### Example Management Platform

FIG. 3 is a block diagram of an example service of patient management platform 150 that may be deployed within the system of FIG. 1, according to some examples. Training input 310 includes model parameters 312 and training data 320 (e.g., training data 220 (FIG. 2)) which may include paired training data sets 322 (e.g., input-output training pairs) and constraints 326. Model parameters 312 stores or provides the parameters or coefficients of corresponding ones of machine learning models. During training, these model parameters 312 are adapted based on the input-output training pairs of the training data sets 322. After the model parameters 312 are adapted (after training), the parameters are used by trained models 360 to implement the trained machine learning models on a new set of data 370.

Training data 320 includes constraints 326 which may define the constraints of a given patient information features. The paired training data sets 322 may include sets of input-output pairs, such as pairs of a plurality of medicinal drug prescription features and features of prior authorizations associated with the medicinal drug prescriptions. The paired training data sets 322 may include sets of input-output pairs, such as pairs of the prior authorizations and prompts used to obtain medical information to respond to prior authorization forms. Some components of training input 310 may be stored separately at a different off-site facility or facilities than other components.

Machine learning model(s) training 330 trains one or more machine learning techniques based on the sets of input-output pairs of paired training data sets 322. For example, the model training 330 may train the machine learning (ML) model parameters 312 by minimizing a loss function based on one or more ground-truth data.

The ML models can include any one or combination of classifiers, LLMs, or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, and the like.

Particularly, a first ML model of the ML models can be applied to a training batch of medicinal drug prescription features and prior authorizations to estimate or generate a prediction of prompts used by an LLM to gather the appropriate set of patient information. In some implementations, a derivative of a loss function is computed based on a comparison of the estimated prediction of the prompts and the ground truth prompts and parameters of the first ML model are updated based on the computed derivative of the loss function. The result of minimizing the loss function for multiple sets of training data trains, adapts, or optimizes the model parameters 312 of the corresponding first ML model. In this way, the first ML model is trained to establish a relationship between a plurality of training medicinal drug prescriptions and ground-truth prompts used to gather patient information for populating forms including inquiries for prior authorization.

A second ML model of the ML models can be applied to prior authorization forms using the prompts generated by the first ML model. Particularly, the second ML model can be an LLM that uses prompts to gather appropriate sets of medication information. The second ML model can be trained to populate or generate responses to inquiries on a form in an automated manner. In some implementations, a third ML model of the ML models can be applied to the prior authorization forms to generate branching logic related to the set of inquiries.

After the machine learning models are trained, new data 370, including one or more medicinal drug prescription features are received and/or derived from a document being accessed by the patient management platform 150. The first trained machine learning model may be applied to the new data 370 to generate results 380 including a prediction of prompts used to gather patient information for populating a prior authorization request. The prompts are applied to the second trained machine learning model to gather or collect necessary patient information and populate the prior authorization form received from one or more entities.

### Example Sequences

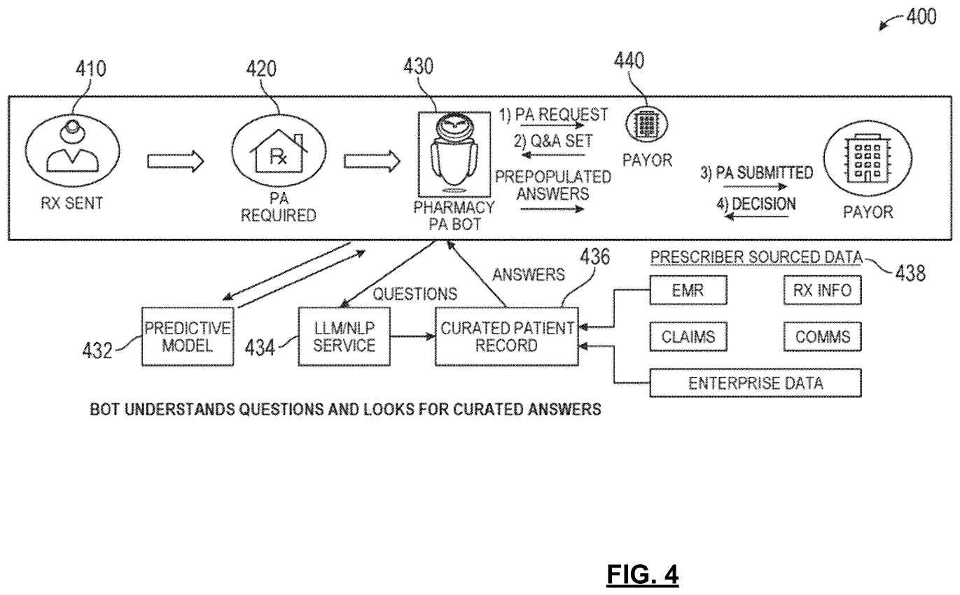

FIG. 4 is a block diagram of an example set of sequences that can be used to perform automated prior authorization, according to some examples. For example, the patient management platform 150 receives a prescription for a drug (e.g., a medicinal drug prescription), via one or more channels 410, by an individual one of the healthcare provider devices 120 of a pharmacist (or clinician). Any discussion pertaining to pharmacists above and below can be similarly applied to clinicians. In some cases, the prescription is received through a fax transmission channel. In such cases, the individual one of the healthcare provider devices 120 of the pharmacist can scan the received fax to generate a document that includes text of the prescription. This document can be uploaded to the patient management platform 150 for further processing. In some cases, the prescription is received through an electronic prescription transmission channel. In such cases, the individual one of the healthcare provider devices 120 of the pharmacist can receive electronically a document that includes text of the prescription which can be automatically uploaded to the patient management platform 150 for further processing. In some cases, the prescription is received through a third-party referral service channel. In such cases, the individual one of the healthcare provider devices 120 of the pharmacist can receive electronically a document that includes text of the prescription which can be automatically uploaded to the patient management platform 150 for further processing. In some cases, the prescription is received through a voice call transmission channel (e.g., through a phone call with the prescribing healthcare professional). In such cases, the individual one of the healthcare provider devices 120 of the pharmacist can draft a document that includes text of the prescription which can then be automatically uploaded to the patient management platform 150 for further processing.

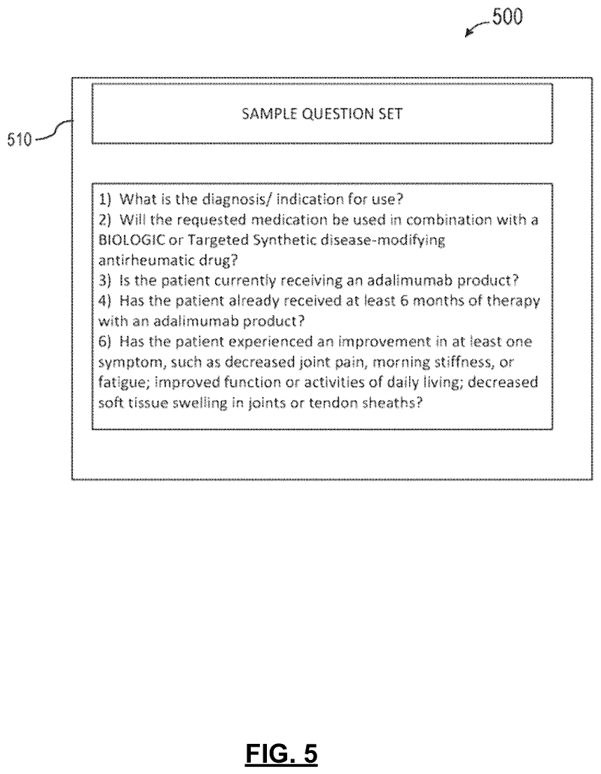

In some examples, the prescription document can be processed by the patient management platform 150. The patient management platform 150 can implement a prior authorization component 420. The prior authorization component 420 can store a database that associates various prescriptions for medicinal drugs with indications of whether such drugs need prior authorization from an entity to be dispensed. The prior authorization component 420 can also store a link to a set of inquiries associated with each prior authorization and/or can store the expected set of inquiries in association with the corresponding prescriptions. For example, as shown in FIG. 5, a set of inquiries 510 can be retrieved in association with a particular prescription or set of prescriptions. The prior authorization component 420 can receive the prescription from the one or more channels 410. The prior authorization component 420 can then process the prescription (e.g., using a machine learning model) to identify the prescription in the database and obtain the expected set of inquiries for the prescription in response to determining that the prescription needs prior authorization.

In such cases, the prior authorization component 420 provides the prescription and/or the set of expected inquiries, such as in a form, to one or more machine learning models 430 (referred to as a pharmacy bot). The one or more machine learning models 430 process the prescription using a predictive model 432. The predictive model 432 can generate a set of prompts that are used to gather patient information for responding to the set of expected inquiries. The predictive model 432 provides the set of prompts to an LLM service 434. The LLM service 434 can then communicate or access a set of patient information 438, such as from the database 152. Namely, the LLM service 434 uses the set of prompts to retrieve the appropriate set of patient information 438. The LLM service 434 can then generate a curated patient record 436 that includes only the portion of the set of patient information 438 that is expected to be needed to respond to inquiries associated with the prior authorization for the prescription drug.

In some examples, the predictive model 432 in addition to or alternative to generating prompts can perform other predictions. For example, the predictive model 432 can obtain responses from the LLM service 434 to the set of inquiries (e.g., set of inquiries 510). The predictive model 432 can be trained to process the responses and generate a prediction on whether the responses result in approval or denial of the prior authorization.

In some implementations, responses to the set of inquiries are obtained directly from the set of patient information for example, by applying the LLM service 434 directly to the set of patient data and the set of inquiries. In some implementations, the set of patient data is processed to create a middle layer of raw processed data (for example, a SQL table). The processed data is then analyzed by the LLM service 434. In some implementations, the responses to the inquiries are displayed in verbiage (in other words, in sentence format). In some implementations, the responses to the set of inquiries are displayed with related information (for example, the information that informed the verbiage response and/or additional information that is tangential to the response). For example, if an inquiry asked a patient's BMI, the related data may include the BMI, height, and/or weight. In some implementations, the data source is presented with the response to the inquiry (for example, displaying a highlighted PDF where the source data is located or a portion of a document where the source information is located). In some implementations, answers to the set of inquiries are displayed and translated from the original format (such as a table, paragraph form, handwritten notes, etc.) to a standardized format to increase user readability and efficiency.

In some implementations, generating the curated patient record 436 includes determining whether information is current: for example, distinguishing between a patient's current weight and a previous weight, or a medication currently taken by a patient versus a discontinued medication. In some implementations, related text may be analyzed for explicitly statements of whether the data is current or not (for example, notes that state a medication is discontinued). In some implementations whether data is current is inferred by associated start and/or end dates, the date of the data source, and/or other verbiage extracted from the data source.

In such cases, the predictive model 432 can be trained based on training data to obtain a set of training responses to a set of training inquiries. The training data can associate the set of training responses with ground truth decisions (approval or denial). The predictive model 432 can process a first batch of the training responses and generate an estimate of a decision (approval or denial). The predictive model 432 can obtain the ground truth decision and compare the ground truth decision with the estimated decision. The predictive model 432 can compute a deviation based on the comparison and update parameters of the predictive model 432 based on the deviation. The predictive model 432 can then continue processing additional batches of the training data until a stopping criterion is reached or satisfied.

The one or more machine learning models 430 can then generate a prior authorization request. The one or more machine learning models 430 can transmit the prior authorization request to one or more entities 440 (e.g., a payor and/or insurance provider). The one or more machine learning models 430 receives a first form that includes a first set of inquiries from a first of the one or more entities 440. The one or more machine learning models 430 processes the first from by the LLM service 434 to automatically populate the first set of inquiries with information included in the curated patient record 436. In some cases, different forms can request the same type of information using different questions or inquiries. For example, the LLM service 434 can receive a first inquiry from the first entity in a first format and can generate a response that includes a first portion of the curated patient record 436 in response to determining that the first inquiry in the first format corresponds to a first type of patient information.

The one or more machine learning models 430 receives a second form that includes a second set of inquiries from a second of the one or more entities 440. The LLM service 434 can receive a second inquiry from the second entity in the second form in a second format and can generate a response that includes the first portion of the curated patient record 436 in response to determining that the second inquiry in the second format also corresponds to the first type of patient information.

In some cases, the one or more machine learning models 430 determines that one or more inquiries in the form received from the first/second entities lacks information in the curated patient record 436. Namely, the one or more machine learning models 430 can determine that a response to the one or more inquires cannot be automatically generated using the curated patient record 436. In such cases, the one or more machine learning models 430 can present a prompt to a medical professional, such as on the client devices 110. The client devices 110 can present an identifier of the medical prescription, the incomplete form populated by the one or more machine learning models 430 (e.g., the form with the inquiries received from the one or more entities 440 and pre-populated responses that were automatically generated by the one or more machine learning models 430 for some of the inquiries). The client devices 110 can present in the user interface or prompt an indication of which portions or inquiries in the form the one or more machine learning models 430 was unable to populate automatically using the curated patient record 436. The client devices 110 can receive input from the medical professional that populates the missing portions of the form.

The client devices 110 can receive input that selects a submit option. In response, the one or more machine learning models 430 transmits the form which has been at least partially or completely populated by the one or more machine learning models 430 to the one or more entities 440. The one or more entities 440 can then generate a decision and provide the decision back to the one or more machine learning models 430. In cases where the one or more machine learning models 430 is able to completely populate the set of inquiries received from the one or more entities 440, the one or more machine learning models 430 automatically transmits the populated form back to the one or more entities 440 without involving the client devices 110. The one or more machine learning models 430, in such cases, can present a prompt or notification on the client devices 110 indicating that the prior authorization has been automatically completed along with the decision received from the one or more entities 440 for the prescription received from the one or more channels 410.

### Flowchart

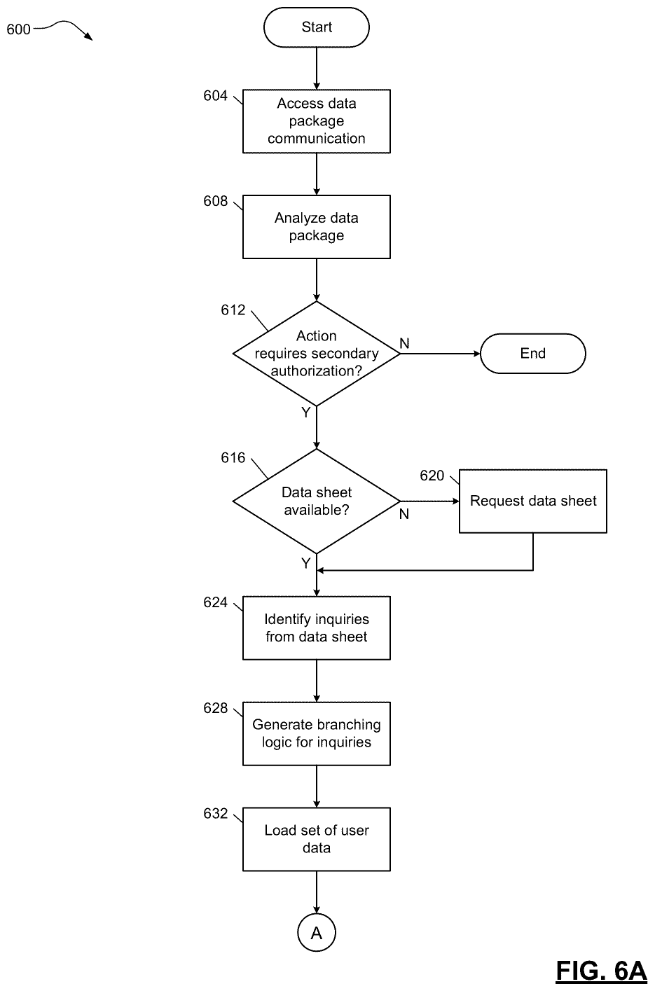

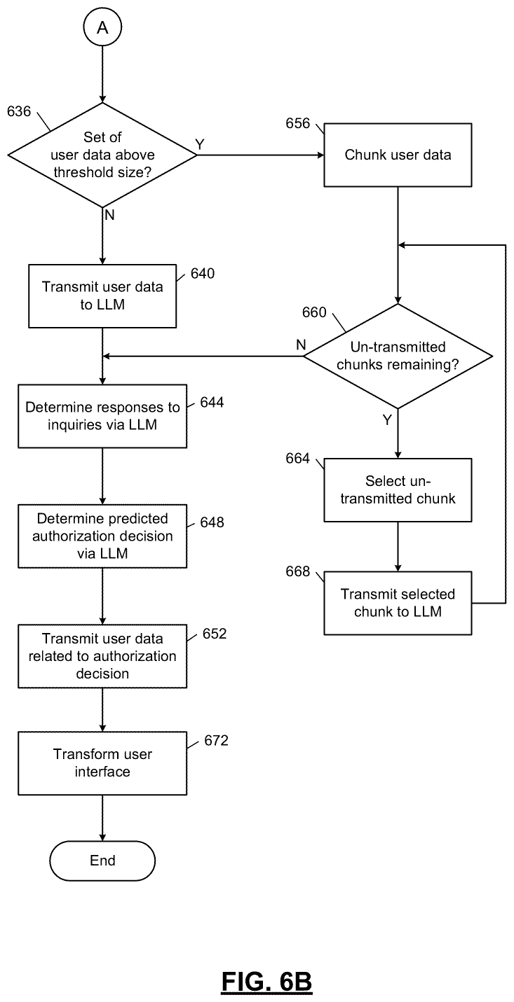

FIGS. 6A-6B are a flowchart illustrating example operations and methods of the patient management platform 150 in performing a method or process 600, according to some examples. The process 600 may be embodied in computer-readable instructions for execution by one or more processors such that the operations of the process 600 may be performed in part or in whole by the functional components of the system 100; accordingly, the process 600 is described below by way of example with reference thereto. However, in other embodiments, at least some of the operations of the process 600 may be deployed on various other hardware configurations. Some or all of the operations of process 600 can be in parallel, out of order, or entirely omitted.

Control begins at 604 and accesses a data package (for example, a data package related to an object such as a medicinal drug). At 608, control analyzes the data package. At 612, control determines, based on the analysis at 608, whether the execution of an action based on the data package requires a secondary authorization (for example, the secondary authorization may include prior authorization from an insurance provider). If no secondary authorization is required, control ends. If secondary authorization is required, control transfers to 616. At 616, control determines whether a datasheet (that includes a set of inquiries) related to the data package is available (for example, control determines whether the data sheet is stored in an accessible database). If the data sheet is available, control transfers to 624. If the data sheet is not available, control transfers to 620 and requests the data sheet (for example, control requests the data sheet by accessing a link to the data sheet, and/or by generating a message to a supplier of the data sheet). At 624, control identifies (for example, via a machine learning model) the set of inquiries from the data sheet and continues to 628. At 628, control generates the branching logic related for the set of inquiries. Generating the branching logic determines which inquiries must be answered and thus which information must be located and responses generated.

At 632, the set of user data (in other words, the user data that will be used to generate responses to the set of inquiries) is loaded. At 636, control determines whether the set of user data is above at threshold size. If the set of user data is above a threshold size, control transfers to 656. If the set of user data is below the threshold size, control transfers to 640. At 640, control transmits the user data to the machine learning model. Control then continues to 644.

At 656, control separates the data into chunks (also called segments). In some implementations, the entirety of the user data is chunked and transmitted to a machine learning model for analysis. In some implementations, data chunks that meet a threshold similarity (such as cosine similarity) compared to the set of inquiries are transmitted to the machine learning model for analysis. In some implementations, the user data is chunked based on the location of a new NLP entity created from the user data.

After chunking the user data, control continues to 660. At 660, control determines whether there are un-transmitted chunks (or in some implementations, un-transmitted chunks that meet the similarity threshold or proximity threshold) that have not yet been transmitted. If no un-transmitted chunks remain, control transfers to 644. If un-transmitted chunks remain, control transfers to 664. At 664, control selects an un-transmitted chunk, and at 668, control transmits the selected chunk. Control then returns to 660.

At 644, control determines via the machine learning model responses to the set of inquiries. At 648, control determines a predicted authorization decision via the machine learning model. At 652, control transmits the user data related to the authorization decision (for example, the response to the inquiries). At 672, control transforms a user interface to display the responses to the inquiries, data related to the inquiries, responses, and/or a data sources for the responses.

### EXAMPLES

Example 1. A method comprising: accessing a communication comprising a medicinal drug prescription associated with a need for prior authorization from an entity; processing, by a machine learning model, the communication to identify an expected set of inquiries corresponding to the prior authorization for the medicinal drug prescription; searching, by the machine learning model, a set of patient information associated with the set of inquiries; and providing a subset of the set of patient information to the entity in response to transmitting to the entity a request for the prior authorization for the medicinal drug prescription.

Example 2. The method of Example 1, further comprising: receiving the medicinal drug prescription from a medical professional; determining that the medicinal drug prescription requires the prior authorization from the entity; and providing the medicinal drug prescription to the machine learning model in response to determining that the medicinal drug prescription requires the prior authorization from the entity.

Example 3. The method of any one of Examples 1-2, wherein the machine learning model comprises a large language model (LLM).

Example 4. The method of any one of Examples 1-3, wherein the machine learning model comprises an artificial neural network.

Example 5. The method of any one of Examples 1-4, further comprising: transmitting to the entity the request for the prior authorization for the medicinal drug prescription; receiving, from the entity, a message comprising a list of inquiries corresponding to the prior authorization; and generating, by the machine learning model, a response to the message based on the subset of the set of patient information.

Example 6. The method of Example 5, wherein the list of inquiries is a subset of the expected set of inquiries.

Example 7. The method of any one of Examples 5-6, further comprising: receiving a form comprising the list of inquiries; and populating the form using the subset of the set of patient information to generate the response.

Example 8. The method of Example 7, further comprising: determining that one or more inquiries in the set of inquiries fails to match any portion of the set of patient information; and in response to determining that the one or more inquiries in the set of inquiries fails to match any portion of the set of patient information, prompting a medical professional to obtain data corresponding to an answer to the one or more inquiries, the response being generated based on the data obtained from the medical professional.

Example 9. The method of any one of Examples 1-8, wherein the set of patient information comprises an electronic medical record associated with a patient corresponding to the medicinal drug prescription, past prescription information of the patient, past medical claims of the patient, past communications exchanged between the patient and one or more medical professionals, and medical information stored on a server that hosts the machine learning model.

Example 10. The method of any one of Examples 1-9, wherein the entity comprises a payor of the medicinal drug prescription.

Example 11. The method of any one of Examples 1-10, further comprising: receiving a decision associated with the prior authorization from the entity in response to providing the subset of the set of patient information to the entity.

Example 12. The method of any one of Examples 1-11, further comprising: accessing a database comprising an association between different sets of inquiries and different types of medicinal drug prescriptions; identifying the medicinal drug prescription in the database; and retrieving the expected set of inquiries from the database that is associated with the medicinal drug prescription.

Example 13. The method of any one of Examples 1-12, further comprising: receiving a first inquiry from the entity in a first format; and generating, by the machine learning model, a response comprising a first portion of the set of patient information in response to determining by the machine learning model that the first inquiry in the first format corresponds to a first type of patient information.

Example 14. The method of Example 13, wherein the entity is a first entity, further comprising: receiving a second inquiry from a second entity in a second format; and generating, by the machine learning model, an additional response comprising the first portion of the set of patient information in response to determining by the machine learning model that the second inquiry in the second format also corresponds to the first type of patient information.

Example 15. The method of any one of Examples 1-14, further comprising training the machine learning model by performing training operations comprising: obtaining a batch of training data comprising a first collection of prior authorization responses associated with a first set of ground truth decisions; processing the first collection of prior authorization responses by the machine learning model to generate an estimated set of decisions; computing a loss based on a deviation between the estimated set of decisions and the first set of ground truth decisions; and updating one or more parameters of the machine learning model based on the computed loss.

Example 16. The method of any one of Examples 1-15, further comprising: generating a prompt comprising the expected set of inquiries for the medicinal drug prescription.

Example 17. The method of any one of Example 16, further comprising: processing, by the machine learning model, the prompt to obtain the set of patient information.

Example 18. A system comprising: one or more processors coupled to a memory comprising non-transitory computer instructions that when executed by the one or more processors perform operations comprising: accessing a communication comprising a medicinal drug prescription associated with a need for prior authorization from an entity; processing, by a machine learning model, the communication to identify an expected set of inquiries corresponding to the prior authorization for the medicinal drug prescription; searching, by the machine learning model, a set of patient information associated with the set of inquiries; and providing a subset of the set of patient information to the entity in response to transmitting to the entity a request for the prior authorization for the medicinal drug prescription.

Example 19. The system of Example 18, the operations comprising: receiving the medicinal drug prescription from a medical professional; determining that the medicinal drug prescription requires the prior authorization from the entity; and providing the medicinal drug prescription to the machine learning model in response to determining that the medicinal drug prescription requires the prior authorization from the entity.

Example 20. A non-transitory computer readable medium comprising non-transitory computer-readable instructions for performing operations comprising: accessing a communication comprising a medicinal drug prescription associated with a need for prior authorization from an entity; processing, by a machine learning model, the communication to identify an expected set of inquiries corresponding to the prior authorization for the medicinal drug prescription; searching, by the machine learning model, a set of patient information associated with the set of inquiries; and providing a subset of the set of patient information to the entity in response to transmitting to the entity a request for the prior authorization for the medicinal drug prescription.

### Example Software Architecture

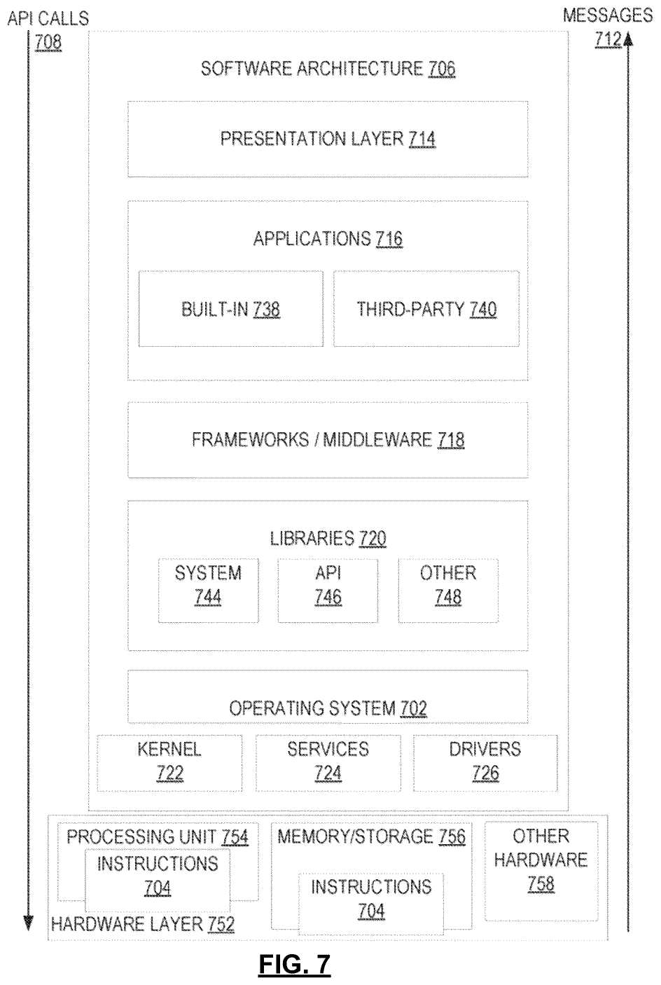

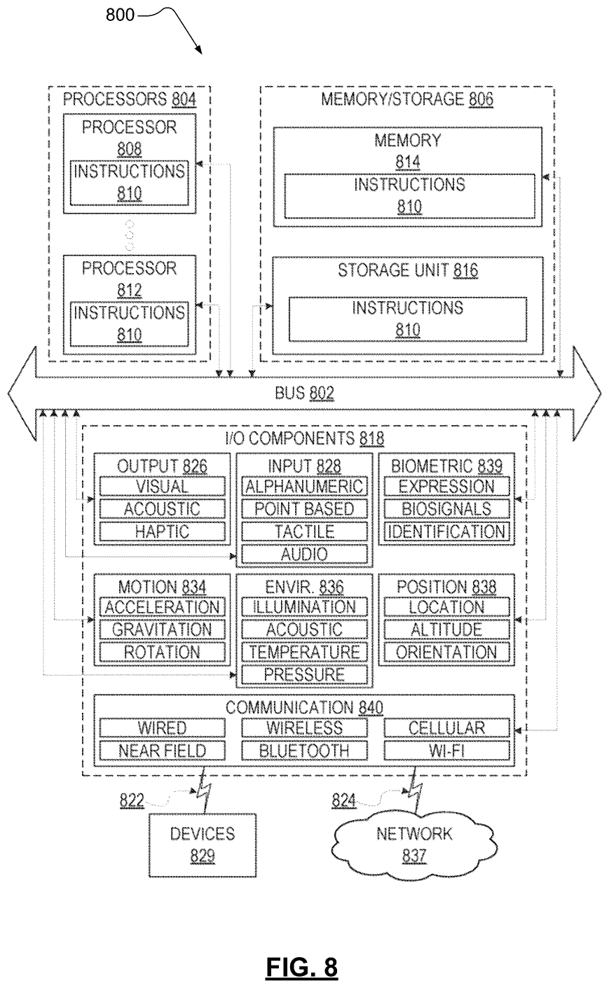

FIG. 7 is a block diagram illustrating an example software architecture 706, which may be used in conjunction with various hardware architectures herein described. FIG. 7 is a non-limiting example of a software architecture, and it will be appreciated that many other architectures may be implemented to facilitate the functionality described herein. The software architecture 706 may execute on hardware such as machine 800 of FIG. 8 that includes, among other things, processors 804, memory 814, and input/output (I/O) components 818. A representative hardware layer 752 is illustrated and can represent, for example, the machine 800 of FIG. 8. The representative hardware layer 752 includes a processing unit 754 having associated executable instructions 704. Executable instructions 704 represent the executable instructions of the software architecture 706, including implementation of the methods, components, and so forth described herein. The hardware layer 752 also includes memory and/or storage devices memory/storage 756, which also have executable instructions 704. The hardware layer 752 may also comprise other hardware 758. The software architecture 706 may be deployed in any one or more of the components shown in FIG. 1. The software architecture 706 can be utilized to apply a machine learning technique or model to automatically complete a prior authorization for a medical prescription.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke API calls 708 through the software stack and receive messages 712 in response to the API calls 708. The layers illustrated are representative in nature and not all software architectures have all layers. For example, some mobile or special purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than to interface directly with the underlying operating system 702 functionality (e.g., kernel 722, services 724 and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media format such as MPREG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/devices.

The frameworks/middleware 718 (also sometimes referred to as middleware) provide a higher-level common infrastructure that may be used by the applications 716 and/or other software components/devices. For example, the frameworks/middleware 718 may provide various graphic user interface functions, high-level resource management, high-level location services, and so forth. The frameworks/middleware 718 may provide a broad spectrum of other APIs that may be utilized by the applications 716 and/or other software components/devices, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. Third-party applications 740 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 740 may invoke the API calls 708 provided by the mobile operating system (such as operating system 702) to facilitate functionality described herein.

The applications 716 may use built-in operating system functions (e.g., kernel 722, services 724, and/or drivers 726), libraries 720, and frameworks/middleware 718 to create UIs to interact with users of the system. Alternatively, or additionally, in some systems, interactions with a user may occur through a presentation layer, such as presentation layer 714. In these systems, the application/component “logic” can be separated from the aspects of the application/component that interact with a user.

### Components

FIG. 8 is a block diagram illustrating components of a machine 800, according to some examples, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. For example, the instructions 810 may be executed by the system 100 to process a medicinal drug prescription document or communication by the patient management platform 150 with trained machine learning models to automatically complete a prior authorization process for the drug prescription.

As such, the instructions 810 may be used to implement devices or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to a server computer, a client computer, a personal computer (PC), a tablet computer, a laptop computer, a netbook, a STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. In an example embodiment, the processors 804 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 808 and a processor 812 that may execute the instructions 810. The term “processor” is intended to include multi-core processors 804 that may comprise two or more independent processors (sometimes referred to as “cores”) that may execute instructions contemporaneously. Although FIG. 8 shows multiple processors 804, the machine 800 may include a single processor with a single core, a single processor with multiple cores (e.g., a multi-core processor), multiple processors with a single core, multiple processors with multiple cores, or any combination thereof.

The memory/storage 806 may include a memory 814, such as a main memory, or other memory storage, database 152, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine.

For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various example embodiments, the I/O components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further examples, the I/O components 818 may include biometric components 839, motion components 834, environmental components 836, or position components 838 among a wide array of other components. For example, the biometric components 839 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 837 or devices 829 via coupling 824 and coupling 822, respectively. For example, the communication components 840 may include a network interface component or other suitable device to interface with the network 837. In further examples, communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 829 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geo-location, location via Wi-Fi® signal triangulation, location via detecting a NFC beacon signal that may indicate a particular location, and so forth.

### Neural Network and Machine Learning

FIG. 9 is a graphical representation of an example neural network with no hidden layers for implementing a machine learning module. In machine learning, a neural network—or an artificial neural network— is a network or circuit of artificial neurons or nodes having at least an input layer and an output layer. In various implementations, neural networks may also have one or more hidden layers. Neural networks may be used in deep learning applications to allow computer systems to solve artificial intelligence problems such as problems in predictive modeling, pattern recognition, and dynamic control systems.

FIG. 9 shows a neural network without any hidden layers. The neural network of FIG. 9 may also be referred to as a single-layer perceptron. The neural network of FIG. 9 is shown with an input layer including n nodes, labeled x₁, x₂, x₃, and xₙ. While only four nodes are illustrated in FIG. 9, the input layer may have any number of nodes. In various implementations, each node may represent any numerical value. For example, each node may represent a numerical value in a range of between 0 and 1. So, for example, the nodes of the input layer could be expressed in interval notation as: x₁∈[0,1], x₂∈[0,1], x₃∈[0,1], and xₙ E [0,1]. In various implementations, the input variables to a neural network may be expressed as a vector i having n dimensions. In the example of FIG. 9, input vector i may be represented by equation (1) below:

$$i = 〈 {x}_{1} , {x}_{2} , {x}_{3} , {x}_{n} 〉 . \qquad ( 1 )$$

Each of the nodes may be multiplied by a weight represented by w₁, w₂, w₃, and wₙ in FIG. 9 before being fed into a node in the next layer. In FIG. 9, because there are no hidden layers, the next layer is the output layer. For simplicity of illustration, only a single node is shown in the output layer of FIG. 9. However, the output layer may include any number of nodes.

At the node in the next layer, the inputs of the node are summed. Thus, because the inputs of the node in the output layer of FIG. 9 are the numerical value of each of the nodes of the previous layer multiplied by a weight, the summation Σ may be represented by equation (2) below:

$$\sum = {x}_{1} {w}_{1} + {x}_{2} {w}_{2} + {x}_{3} {w}_{3} + {x}_{n} {w}_{n} . \qquad ( 2 )$$

In various implementations, a bias b may be added to the nodes x of the previous layer after they have been multiplied by a weight w. For example, if biases b are added, then summation Σ may be represented by equation (3) below:

$$\sum = ( {x}_{1} {w}_{1} + {b}_{1} ) + ( {x}_{2} {w}_{2} + {b}_{2} ) + ( {x}_{3} {w}_{3} + {b}_{3} ) + ( {x}_{n} {w}_{n} + {b}_{n} ) \qquad ( 3 )$$

The summation Σ may then be fed into an activation function ƒ. The activation function ƒ may be any mathematical function suitable for calculating an output for the node. Example activation functions ƒ may include linear or non-linear functions, step functions such as the Heaviside step function, derivative or differential functions, monotonic functions, sigmoid or logistic activation functions, rectified linear unit (ReLU) functions, and/or leaky ReLU functions. The output of the function ƒ is then the output of the node. In a neural network with no hidden layers— such as the single-layer perceptron shown in FIG. 9—the output of the nodes in the output layer are the output variables or output vector of the neural network.

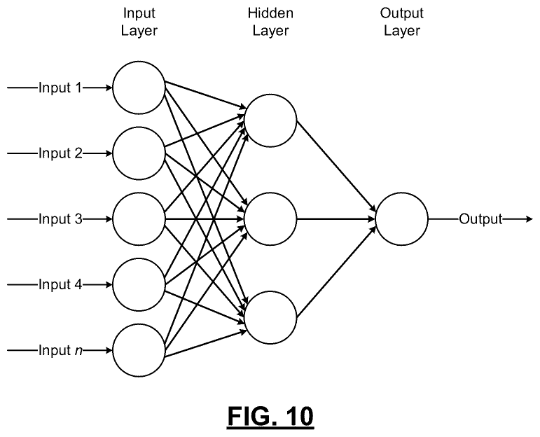

FIG. 10 is a graphical representation of an example neural network with one hidden layer for implementing the machine learning module. As illustrated in FIG. 10, the neural network may one or more intermediate layers—referred to as hidden layers—between the input layer and the output layer. The neural network of FIG. 10 may be referred to as a multilayer perceptron. Each node of a hidden layer may be connected to one or more nodes of the previous layer—and receive inputs from the connected nodes of the previous layer such as the value of the node of the previous layer multiplied by a weight (xₙwₙ) or the value of the node of the previous layer multiplied by a weight with a bias added (xₙwₙ+bₙ). Each node of the hidden layer may then function in a manner analogous to the node of the output layer of FIG. 9 by summing the inputs, feeding the summed inputs into an activation function, and feeding the output of the activation function into one or more nodes of the next layer. Similarly, the nodes of the output layer function in a manner analogous to the node of the output layer of FIG. 9. For example, the nodes of the output layer may receive the outputs of the nodes of the previous layer (multiplied by a weight and/or with a bias added as desired) as inputs, sum the received inputs, feed the summed inputs to an activation function, and output the result of the activation function as an output of the neural network.

In various implementations, the neural network may have any number of hidden layers. In various implementations, each node of a previous layer may be connected to any number of nodes of a next layer. For example, as shown in FIG. 10, each node of the previous layer may be connected to each node of the next layer. Such a neural network may be referred to as a fully-connected neural network. In various implementations, each layer of the neural network may have any number of nodes. In various implementations, a neural network with no hidden layers may function as a linear classifier and be suitable for representing linearly separable decisions or functions. In various implementations, neural networks with one hidden layer may be suitable for performing continuous mapping from one finite space to another. In various implementations, neural networks with two hidden layers may be suitable for approximating any smooth mapping to any level of accuracy.

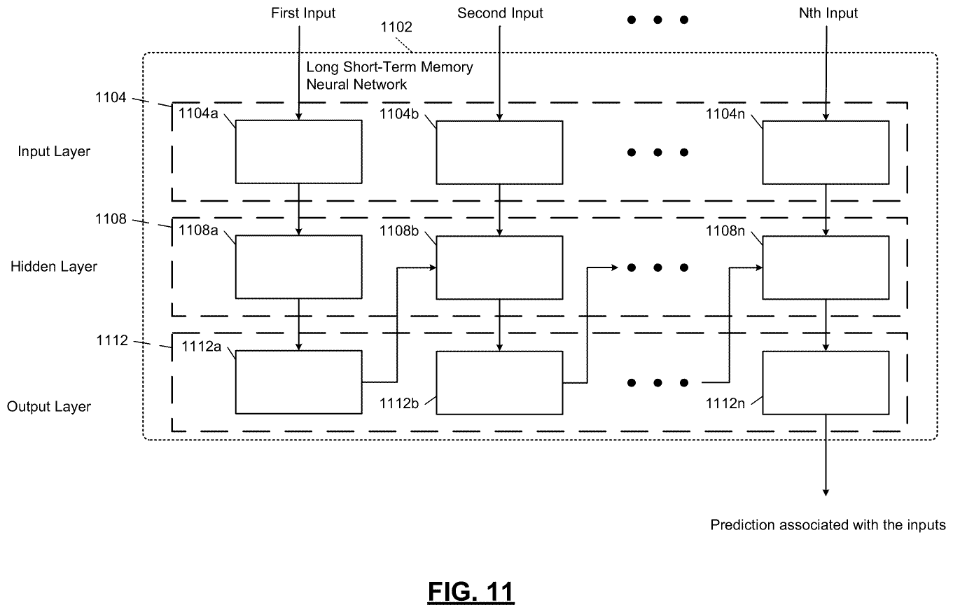

FIG. 11 is a functional block diagram of an example neural network 1102 that can be used for the inference engine or other functions (e.g., engines) as described herein to produce a predictive model. The predictive model can identify or generate decisions associated with prior authorization responses for medicinal drug prescriptions. In an example, the neural network 1102 can be a LSTM neural network. In an example, the neural network 1102 can be a recurrent neural network (RNN). The example neural network 1102 may be used to implement the machine learning as described herein, and various implementations may use other types of machine learning networks. The neural network 1102 includes an input layer 1104, a hidden layer 1108, and an output layer 1112. The input layer 1104 includes inputs 1104a, 1104b . . . 1104n. The hidden layer 1108 includes neurons 1108a, 1108b . . . 1108n. The output layer 1112 includes outputs 1112a, 1112b . . . 1112n.

Each neuron of the hidden layer 1108 receives an input from the input layer 1104 and outputs a value to the corresponding output in the output layer 1112. For example, the neuron 1108a receives an input from the input 1104a and outputs a value to the output 1112a. Each neuron, other than the neuron 1108a, also receives an output of a previous neuron as an input. For example, the neuron 1108b receives inputs from the input 1104b and the output 1112a. In this way the output of each neuron is fed forward to the next neuron in the hidden layer 1108. The last output 1112n in the output layer 1112 outputs a probability associated with the inputs 1104a-1104n. Although the input layer 1104, the hidden layer 1108, and the output layer 1112 are depicted as each including three elements, each layer may contain any number of elements. Neurons can include one or more adjustable parameters, weights, rules, criteria, or the like.

In various implementations, each layer of the neural network 1102 must include the same number of elements as each of the other layers of the neural network 1102. For example, training features (e.g., collection of drug prescription prior authorization inquiry responses associated with a first set of ground truth decisions) may be processed to create the inputs 1104a-1104n.

The neural network 1102 may implement a first model to produce estimated decisions for the prior authorization responses. More specifically, the inputs 1104a-1104n can include fields of the prescription as data features (binary, vectors, factors or the like) stored in the storage device 110. The features of the prescription can be provided to neurons 1108a-1108n for analysis and connections between the known facts. The neurons 1108a-1108n, upon finding connections, provides the potential connections as outputs to the output layer 1112, which determines a set of prompts associated with the prescription.

The neural network 1102 can perform any of the above calculations. The output of the neural network 1102 can be used to control an LLM to retrieve the appropriate set of medical information needed to populate a prior authorization form. In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1104a is connected to each of neurons 1108a, 1108b . . . 1108n.

### High-Volume Pharmacy

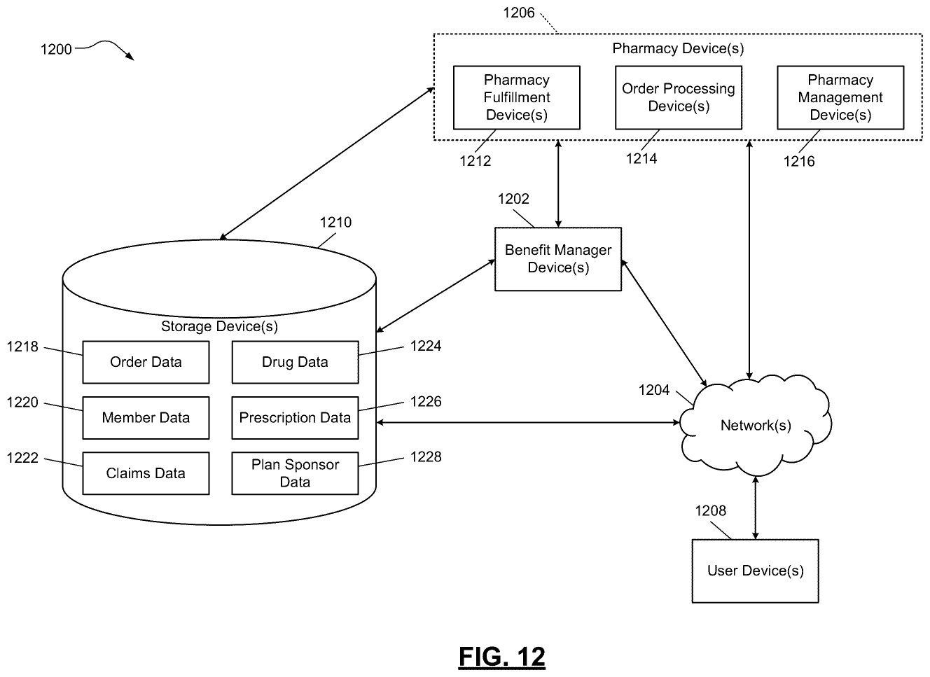

FIG. 12 is a block diagram of an example implementation of a system 1200 for a high-volume pharmacy. While the system 1200 is generally described as being deployed in a high-volume pharmacy or a fulfillment center (for example, a mail order pharmacy, a direct delivery pharmacy, etc.), the system 1200 and/or components of the system 1200 may otherwise be deployed (for example, in a lower-volume pharmacy, etc.). A high-volume pharmacy may be a pharmacy that is capable of filling at least some prescriptions mechanically. The system 1200 may include a benefit manager device 1202 and a pharmacy device 1206 in communication with each other directly and/or over a network 1204.

The system 1200 may also include one or more user device(s) 1208. A user, such as a pharmacist, patient, data analyst, health plan administrator, etc., may access the benefit manager device 1202 or the pharmacy device 1206 using the user device 1208. The user device 1208 may be a desktop computer, a laptop computer, a tablet, a smartphone, etc.

The benefit manager device 1202 is a device operated by an entity that is at least partially responsible for creation and/or management of the pharmacy or drug benefit. While the entity operating the benefit manager device 1202 is typically a pharmacy benefit manager (PBM), other entities may operate the benefit manager device 1202 on behalf of themselves or other entities (such as PBMs). For example, the benefit manager device 1202 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 1202 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 1200. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 1200. The pharmacy benefit plan is administered by or through the benefit manager device 1202.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 1210 or determined by the benefit manager device 1202.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 1202) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the system 1200) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 1202 and/or an additional device.

Examples of the network 1204 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 1204 may include an optical network. The network 1204 may be a local area network or a global communication network, such as the Internet. In some implementations, the network 1204 may include a network dedicated to prescription orders: a prescribing network such as the electronic prescribing network operated by Surescripts of Arlington, Virginia.

Moreover, although the system shows a single network 1204, multiple networks can be used. The multiple networks may communicate in series and/or parallel with each other to link the devices 1202-1210.

The pharmacy device 1206 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 1206 to submit the claim to the PBM for adjudication.

Additionally, in some implementations, the pharmacy device 1206 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 1202 may track prescription drug fulfillment and/or other information for users that are not members, or have not identified themselves as members, at the time (or in conjunction with the time) in which they seek to have a prescription filled at a pharmacy.

The pharmacy device 1206 may include a pharmacy fulfillment device 1212, an order processing device 1214, and a pharmacy management device 1216 in communication with each other directly and/or over the network 1204. The order processing device 1214 may receive information regarding filling prescriptions and may direct an order component to one or more devices of the pharmacy fulfillment device 1212 at a pharmacy. The pharmacy fulfillment device 1212 may fulfill, dispense, aggregate, and/or pack the order components of the prescription drugs in accordance with one or more prescription orders directed by the order processing device 1214.

In general, the order processing device 1214 is a device located within or otherwise associated with the pharmacy to enable the pharmacy fulfillment device 1212 to fulfill a prescription and dispense prescription drugs. In some implementations, the order processing device 1214 may be an external order processing device separate from the pharmacy and in communication with other devices located within the pharmacy.

For example, the external order processing device may communicate with an internal pharmacy order processing device and/or other devices located within the system 1200. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 1214 may track the prescription order as it is fulfilled by the pharmacy fulfillment device 1212. The prescription order may include one or more prescription drugs to be filled by the pharmacy. The order processing device 1214 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 1214 may also track and/or schedule literature or paperwork associated with each prescription order or multiple prescription orders that are being shipped together. In some implementations, the order processing device 1214 may operate in combination with the pharmacy management device 1216.

The order processing device 1214 may include circuitry, a processor, a memory to store data and instructions, and communication functionality. The order processing device 1214 is dedicated to performing processes, methods, and/or instructions described in this application. Other types of electronic devices may also be used that are specifically configured to implement the processes, methods, and/or instructions described in further detail below.

In some implementations, at least some functionality of the order processing device 1214 may be included in the pharmacy management device 1216. The order processing device 1214 may be in a client-server relationship with the pharmacy management device 1216, in a peer-to-peer relationship with the pharmacy management device 1216, or in a different type of relationship with the pharmacy management device 1216. The order processing device 1214 and/or the pharmacy management device 1216 may communicate directly (for example, such as by using a local storage) and/or through the network 1204 (such as by using a cloud storage configuration, software as a service, etc.) with the storage device 1210.

The storage device 1210 may include: non-transitory storage (for example, memory, hard disk, CD-ROM, etc.) in communication with the benefit manager device 1202 and/or the pharmacy device 1206 directly and/or over the network 1204. The non-transitory storage may store order data 1218, member data 1220, claims data 1222, drug data 1224, prescription data 1226, and/or plan sponsor data 1228. Further, the system 1200 may include additional devices, which may communicate with each other directly or over the network 1204.

The order data 1218 may be related to a prescription order. The order data may include type of the prescription drug (for example, drug name and strength) and quantity of the prescription drug. The order data 1218 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 1218 may be used by a high-volume fulfillment center to fulfill a pharmacy order.

In some implementations, the order data 1218 includes verification information associated with fulfillment of the prescription in the pharmacy. For example, the order data 1218 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 1218.

The member data 1220 includes information regarding the members associated with the PBM. The information stored as member data 1220 may include personal information, personal health information, protected health information, etc. Examples of the member data 1220 include name, age, date of birth, address (including city, state, and zip code), telephone number, e-mail address, medical history, prescription drug history, etc. In various implementations, the prescription drug history may include a prior authorization claim history including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 1220 may also include a plan sponsor identifier that identifies the plan sponsor associated with the member and/or a member identifier that identifies the member to the plan sponsor. The member data 1220 may include a member identifier that identifies the plan sponsor associated with the user and/or a user identifier that identifies the user to the plan sponsor. In various implementations, the member data 1220 may include an eligibility period for each member. For example, the eligibility period may include how long each member is eligible for coverage under the sponsored plan. The member data 1220 may also include dispensation preferences such as type of label, type of cap, message preferences, language preferences, etc.

The member data 1220 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 1220 for review, verification, or other purposes.

In some implementations, the member data 1220 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 1222 includes information regarding pharmacy claims adjudicated by the PBM under a drug benefit program provided by the PBM for one or more plan sponsors. In general, the claims data 1222 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 1222. For example, medical claims, dental claims, wellness claims, or other types of health-care-related claims for members may be stored as a portion of the claims data 1222.

In some implementations, the claims data 1222 includes claims that identify the members with whom the claims are associated. Additionally or alternatively, the claims data 1222 may include claims that have been de-identified (that is, associated with a unique identifier but not with a particular, identifiable member). In various implementations, the claims data 1222 may include a percentage of prior authorization cases for each prescriber that have been denied, and a percentage of prior authorization cases for each prescriber that have been approved.

The drug data 1224 may include drug name (e.g., technical name and/or common name), other names by which the drug is known, active ingredients, an image of the drug (such as in pill form), etc. The drug data 1224 may include information associated with a single medication or multiple medications. For example, the drug data 1224 may include a numerical identifier for each drug, such as the U.S. Food and Drug Administration's (FDA) National Drug Code (NDC) for each drug.

The prescription data 1226 may include information regarding prescriptions that may be issued by prescribers on behalf of users, who may be members of the pharmacy benefit plan for example, to be filled by a pharmacy. Examples of the prescription data 1226 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 1218 may be linked to associated member data 1220, claims data 1222, drug data 1224, and/or prescription data 1226.

The plan sponsor data 1228 includes information regarding the plan sponsors of the PBM. Examples of the plan sponsor data 1228 include company name, company address, contact name, contact telephone number, contact e-mail address, etc.

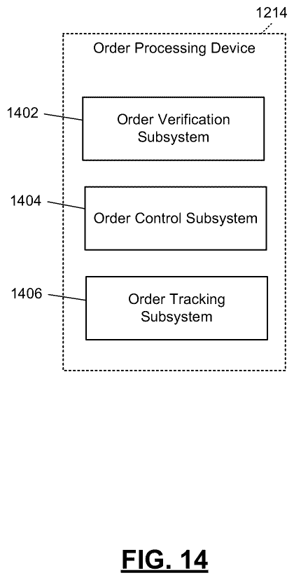

FIG. 14 illustrates the pharmacy fulfillment device 1212 according to an example implementation. The pharmacy fulfillment device 1212 may be used to process and fulfill prescriptions and prescription orders. After fulfillment, the fulfilled prescriptions are packed for shipping.

The pharmacy fulfillment device 1212 may include devices in communication with the benefit manager device 1202, the order processing device 1214, and/or the storage device 1210, directly or over the network 1204. Specifically, the pharmacy fulfillment device 1212 may include pallet sizing and pucking device(s) 1306, loading device(s) 1308, inspect device(s) 1310, unit of use device(s) 1312, automated dispensing device(s) 1314, manual fulfillment device(s) 1316, review devices 1318, imaging device(s) 1320, cap device(s) 1322, accumulation devices 1324, packing device(s) 1326, literature device(s) 1328, unit of use packing device(s) 1330, and mail manifest device(s) 1332. Further, the pharmacy fulfillment device 1212 may include additional devices, which may communicate with each other directly or over the network 1204.

In some implementations, operations performed by one of these devices 1306-1332 may be performed sequentially, or in parallel with the operations of another device as may be coordinated by the order processing device 1214. In some implementations, the order processing device 1214 tracks a prescription with the pharmacy based on operations performed by one or more of the devices 1306-1332.

In some implementations, the pharmacy fulfillment device 1212 may transport prescription drug containers, for example, among the devices 1306-1332 in the high-volume fulfillment center, by use of pallets. The pallet sizing and pucking device 1306 may configure pucks in a pallet. A pallet may be a transport structure for a number of prescription containers, and may include a number of cavities. A puck may be placed in one or more than one of the cavities in a pallet by the pallet sizing and pucking device 1306. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 1214 based on prescriptions that the order processing device 1214 decides to launch. The arrangement logic may be implemented directly in the pallet sizing and pucking device 1306. Once a prescription is set to be launched, a puck suitable for the appropriate size of container for that prescription may be positioned in a pallet by a robotic arm or pickers. The pallet sizing and pucking device 1306 may launch a pallet once pucks have been configured in the pallet.

The loading device 1308 may load prescription containers into the pucks on a pallet by a robotic arm, a pick and place mechanism (also referred to as pickers), etc. In various implementations, the loading device 1308 has robotic arms or pickers to grasp a prescription container and move it to and from a pallet or a puck. The loading device 1308 may also print a label that is appropriate for a container that is to be loaded onto the pallet, and apply the label to the container. The pallet may be located on a conveyor assembly during these operations (e.g., at the high-volume fulfillment center, etc.).

The inspect device 1310 may verify that containers in a pallet are correctly labeled and in the correct spot on the pallet. The inspect device 1310 may scan the label on one or more containers on the pallet. Labels of containers may be scanned or imaged in full or in part by the inspect device 1310. Such imaging may occur after the container has been lifted out of its puck by a robotic arm, picker, etc., or may be otherwise scanned or imaged while retained in the puck. In some implementations, images and/or video captured by the inspect device 1310 may be stored in the storage device 1210 as order data 1218.

The unit of use device 1312 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 1312 may be packaged individually or collectively for shipping, or may be shipped in combination with other prescription drugs dispensed by other devices in the high-volume fulfillment center.

At least some of the operations of the devices 1306-1332 may be directed by the order processing device 1214. For example, the manual fulfillment device 1316, the review device 1318, the automated dispensing device 1314, and/or the packing device 1326, etc. may receive instructions provided by the order processing device 1214.

The automated dispensing device 1314 may include one or more devices that dispense prescription drugs or pharmaceuticals into prescription containers in accordance with one or multiple prescription orders. In general, the automated dispensing device 1314 may include mechanical and electronic components with, in some implementations, software and/or logic to facilitate pharmaceutical dispensing that would otherwise be performed in a manual fashion by a pharmacist and/or pharmacist technician. For example, the automated dispensing device 1314 may include high-volume fillers that fill a number of prescription drug types at a rapid rate and blister pack machines that dispense and pack drugs into a blister pack. Prescription drugs dispensed by the automated dispensing devices 1314 may be packaged individually or collectively for shipping, or may be shipped in combination with other prescription drugs dispensed by other devices in the high-volume fulfillment center.

The manual fulfillment device 1316 controls how prescriptions are manually fulfilled. For example, the manual fulfillment device 1316 may receive or obtain a container and enable fulfillment of the container by a pharmacist or pharmacy technician. In some implementations, the manual fulfillment device 1316 provides the filled container to another device in the pharmacy fulfillment devices 1212 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 1316 may be packaged individually or collectively for shipping, or may be shipped in combination with other prescription drugs dispensed by other devices in the high-volume fulfillment center.

The review device 1318 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 1318 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 1320 may image containers once they have been filled with pharmaceuticals. The imaging device 1320 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 1214 and/or stored in the storage device 1210 as part of the order data 1218.

The cap device 1322 may be used to cap or otherwise seal a prescription container. In some implementations, the cap device 1322 may secure a prescription container with a type of cap in accordance with a user preference (e.g., a preference regarding child resistance, etc.), a plan sponsor preference, a prescriber preference, etc. The cap device 1322 may also etch a message into the cap, although this process may be performed by a subsequent device in the high-volume fulfillment center.

The accumulation device 1324 accumulates various containers of prescription drugs in a prescription order. The accumulation device 1324 may accumulate prescription containers from various devices or areas of the pharmacy. For example, the accumulation device 1324 may accumulate prescription containers from the unit of use device 1312, the automated dispensing device 1314, the manual fulfillment device 1316, and the review device 1318. The accumulation device 1324 may be used to group the prescription containers prior to shipment to the member.

The literature device 1328 prints, or otherwise generates, literature to include with each prescription drug order. The literature may be printed on multiple sheets of substrates, such as paper, coated paper, printable polymers, or combinations of the above substrates. The literature printed by the literature device 1328 may include information required to accompany the prescription drugs included in a prescription order, other information related to prescription drugs in the order, financial information associated with the order (for example, an invoice or an account statement), etc.

In some implementations, the literature device 1328 folds or otherwise prepares the literature for inclusion with a prescription drug order (e.g., in a shipping container). In other implementations, the literature device 1328 prints the literature and is separate from another device that prepares the printed literature for inclusion with a prescription order.

The packing device 1326 packages the prescription order in preparation for shipping the order. The packing device 1326 may box, bag, or otherwise package the fulfilled prescription order for delivery. The packing device 1326 may further place inserts (e.g., literature or other papers, etc.) into the packaging received from the literature device 1328. For example, bulk prescription orders may be shipped in a box, while other prescription orders may be shipped in a bag, which may be a wrap seal bag.

The packing device 1326 may label the box or bag with an address and a recipient's name. The label may be printed and affixed to the bag or box, be printed directly onto the bag or box, or otherwise associated with the bag or box. The packing device 1326 may sort the box or bag for mailing in an efficient manner (e.g., sort by delivery address, etc.). The packing device 1326 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 1330 packages a unit of use prescription order in preparation for shipping the order. The unit of use packing device 1330 may include manual scanning of containers to be bagged for shipping to verify each container in the order. In an example implementation, the manual scanning may be performed at a manual scanning station. The pharmacy fulfillment device 1212 may also include a mail manifest device 1332 to print mailing labels used by the packing device 1326 and may print shipping manifests and packing lists.

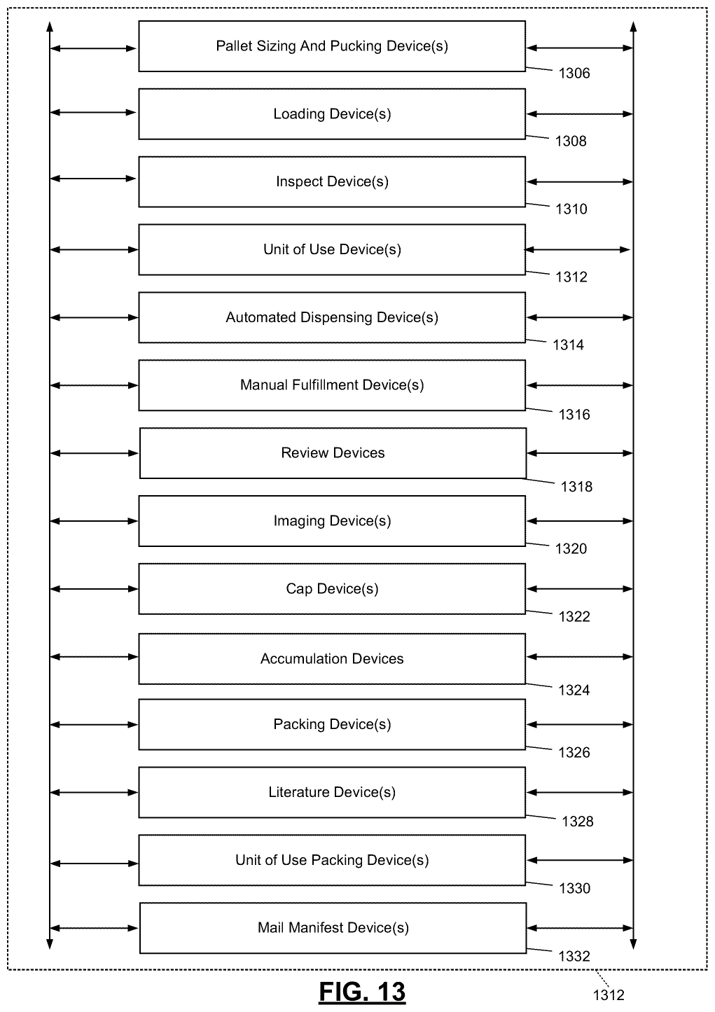

While the pharmacy fulfillment device 1212 in FIG. 13 is shown to include single devices 1306-1332, multiple devices may be used. When multiple devices are present, the multiple devices may be of the same device type or models, or may be a different device type or model. The types of devices 1306-1332 shown in FIG. 13 are example devices. In other configurations of the system 1200, lesser, additional, or different types of devices may be included.

Moreover, multiple devices may share processing and/or memory resources. The devices 1306-1332 may be located in the same area or in different locations. For example, the devices 1306-1332 may be located in a building or set of adjoining buildings. The devices 1306-1332 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

FIG. 14 illustrates the order processing device 1214 according to an example implementation. The order processing device 1214 may be used by one or more operators to generate prescription orders, make routing decisions, make prescription order consolidation decisions, track literature with the system 1200, and/or view order status and other order related information. For example, the prescription order may be comprised of order components.

The order processing device 1214 may receive instructions to fulfill an order without operator intervention. An order component may include a prescription drug fulfilled by use of a container through the system 1200. The order processing device 1214 may include an order verification subsystem 1402, an order control subsystem 1404, and/or an order tracking subsystem 1406. Other subsystems may also be included in the order processing device 1214.

The order verification subsystem 1402 may communicate with the benefit manager device 1202 to verify the eligibility of the member and review the formulary to determine appropriate copayment, coinsurance, and deductible for the prescription drug and/or perform a DUR (drug utilization review). Other communications between the order verification subsystem 1402 and the benefit manager device 1202 may be performed for a variety of purposes.

The order control subsystem 1404 controls various movements of the containers and/or pallets along with various filling functions during their progression through the system 1200. In some implementations, the order control subsystem 1404 may identify the prescribed drug in one or more than one prescription orders as capable of being fulfilled by the automated dispensing device 1314. The order control subsystem 1404 may determine which prescriptions are to be launched and may determine that a pallet of automated-fill containers is to be launched.

The order control subsystem 1404 may determine that an automated-fill prescription of a specific pharmaceutical is to be launched and may examine a queue of orders awaiting fulfillment for other prescription orders, which will be filled with the same pharmaceutical. The order control subsystem 1404 may then launch orders with similar automated-fill pharmaceutical needs together in a pallet to the automated dispensing device 1314. As the devices 1306-1332 may be interconnected by a system of conveyors or other container movement systems, the order control subsystem 1404 may control various conveyors: for example, to deliver the pallet from the loading device 1308 to the manual fulfillment device 1316 from the literature device 1328, paperwork as needed to fill the prescription.

The order tracking subsystem 1406 may track a prescription order during its progress toward fulfillment. The order tracking subsystem 1406 may track, record, and/or update order history, order status, etc. The order tracking subsystem 1406 may store data locally (for example, in a memory) or as a portion of the order data 1218 stored in the storage device 1210.

### Glossary

“CARRIER SIGNAL” in this context refers to any intangible medium that is capable of storing, encoding, or carrying transitory or non-transitory instructions for execution by the machine, and includes digital or analog communications signals or other intangible medium to facilitate communication of such instructions. Instructions may be transmitted or received over the network using a transitory or non-transitory transmission medium via a network interface device and using any one of a number of well-known transfer protocols. The instructions can carry a selected model that automatically copy text from a first interface and automatically identifies a target location in a second interface at which the copied data from the first interface is suggested to be copied.

“CLIENT DEVICE” in this context refers to any machine that interfaces to a communications network to obtain resources from one or more server systems or other client devices. A client device may be, but is not limited to, a mobile phone, desktop computer, laptop, PDA, smart phone, tablet, ultra-book, netbook, laptop, multi-processor system, microprocessor-based or programmable consumer electronics, game console, set-top box, or any other communication device that a user may use to access a network. In an example embodiment, the client device is capable of having two or more display that can have two or more interfaces, from which the system selects information to copy and a target location to insert the copied information on two different interfaces. In an example embodiment, the first interface is different than the second interface. The first interface can be produced a different program than the second interface. The first interface can be operating on a different database than the second interface.

“COMMUNICATIONS NETWORK” in this context refers to one or more portions of a network that may be an ad hoc network, an intranet, an extranet, a virtual private network (VPN), a LAN, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a CPU, a RISC processor, a CISC processor, a GPU, a DSP, an ASIC, a RFIC, or any combination thereof. A processor may further be a multi-core processor having two or more independent processors (sometimes referred to as “cores”) that may execute instructions contemporaneously.

Changes and modifications may be made to the disclosed techniques without departing from the scope of the present disclosure. These and other changes or modifications are intended to be included within the scope of the present disclosure, as expressed in the following claims.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for adapting a user interface, the method comprising:
accessing a data package, wherein the data package specifies an object;
determining whether execution of an action based on the data package requires secondary authorization;
in response to a determination that the execution requires secondary authorization:
identifying a set of inquiries associated with the object,
determining, via a machine learning model, whether user data includes information associated with the set of inquiries,
in response to a determination that the user data includes information associated with the set of inquiries, determining, via the machine learning model, a set of responses to the set of inquiries using the user data, and
transmitting a request for secondary authorization including the set of responses and a first subset of the user data, wherein the set of responses is based on the first subset of the user data, and
transforming the user interface to display the set of responses, the set of inquiries, and the first subset of the user data.

2. The method of claim 1, wherein identifying the set of inquiries includes:
accessing a database including an association between different sets of inquiries and different types of object data packages;
identifying the data package in the database; and
retrieving an expected set of inquiries from the database that is associated with the object.

3. The method of claim 2, wherein:
identifying the set of inquiries includes receiving the set of inquiries; and
the set of inquiries is a subset of the expected set of inquiries.

4. The method of claim 1, further comprising receiving a communication that carries the data package.

5. The method of claim 1, further comprising:
in response to a determination that the user data does not include information associated with the set of inquiries, generating a prompt to obtain additional data corresponding to at least one inquiries of the set of inquiries; and
determining the set of responses using the additional data.

6. The method of claim 1, wherein the user data includes:
an electronic medical record associated with a user, wherein the user is associated with the data package for the object;
past medical prescription information of the user;
past medical claims of the user; and
past communications exchanged between the user and one or more secondary users.

7. The method of claim 1, further comprising receiving a secondary authorization decision.

8. The method of claim 1, further comprising:
receiving a first inquiry in a first format;
determining, via the machine learning model, that the first inquiry corresponds to a first type of user data; and
in response to a determination that the first inquiry corresponds to the first type of user data, generating, via the machine learning model, a first response including a first portion of the user data.

9. The method of claim 8, further comprising:
receiving a second inquiry in a second format;
determining, via the machine learning model, that the second inquiry corresponds to the first type of user data; and
in response to a determination that the second inquiry corresponds to the first type of user data, generating, via the machine learning model, a second response including the first portion of the user data.

10. The method of claim 1, further comprising training the machine learning model by performing training operations including:
obtaining a batch of training data including a first collection of prior authorization responses associated with a first set of ground truth decisions;
processing the first collection of prior authorization responses by the machine learning model to generate an estimated set of decisions;
computing a loss based on a deviation between the estimated set of decisions and the first set of ground truth decisions; and
updating one or more parameters of the machine learning model based on the computed loss.

11. The method of claim 1, further comprising transmitting the user data to the machine learning model in a set of segments.

12. The method of claim 11, further comprising:
determining whether a size of the user data exceeds a size threshold; and
in response to a determination that the size of the user data exceeds a size threshold, separating the user data into the set of segments.

13. The method of claim 12, further comprising:
detecting, using natural language processing, a new language entity; and
generating a first segment of the set of segments that includes data within a proximity limit of the new language entity.

14. The method of claim 12, further comprising:
determining whether a second subset of user data of the user data meets a similarity threshold to one or more inquiries of the set of inquiries; and
in response to a determination that the second subset of user data meets the similarity threshold, generating a second segment of the set of segments that includes the second subset of user data.

15. The method of claim 1, wherein determining whether the user data is associated with the set of inquiries includes determining whether a portion of the user data is current by at least one of:
determining whether the user data describes that the portion is current; or
inferring whether the user data is current based on:
a date associated with a source of the portion, or
one or more dates associated with the portion.

16. The method of claim 1, further comprising transforming the user interface to display a set of sources associated with the first subset of the user data.

17. The method of claim 1, further comprising extracting, by the machine learning model, a set of raw data from the user data.

18. A system comprising:
memory hardware configured to store processor-executable instructions; and
processor hardware configured to execute the instructions stored by the memory hardware, wherein the instructions include:
accessing a communication including a data package for an object,
determining whether the data package requires secondary authorization,
in response to a determination that the data package requires secondary authorization:
identifying a set of inquiries associated with the object,
determining, via a machine learning model, whether user data includes information associated with the set of inquiries,
in response to a determination that the user data includes information associated with the set of inquiries, determining, via the machine learning model, a set of responses to the set of inquiries using the user data, and
transmitting a request for secondary authorization including the set of responses and a first subset of the user data, wherein the set of responses is based on the first subset of the user data, and
transforming a user interface to display the set of responses, the set of inquiries, and the first subset of the user data.

19. The system of claim 18, wherein identifying the set of inquiries includes:
accessing a database including an association between different sets of inquiries and different types of object data packages;
identifying the data package in the database; and
retrieving an expected set of inquiries from the database that is associated with the object.

20. A non-transitory computer readable medium comprising non-transitory computer-readable instructions including:
accessing a communication including a data package for an object;
determining whether the data package requires secondary authorization;
in response to a determination that the data package requires secondary authorization:
identifying a set of inquiries associated with the object,
determining, via a machine learning model, whether user data includes information associated with the set of inquiries,
in response to a determination that the user data includes information associated with the set of inquiries, determining, via the machine learning model, a set of responses to the set of inquiries using the user data, and
transmitting a request for secondary authorization including the set of responses and a first subset of the user data, wherein the set of responses is based on the first subset of the user data, and
transforming a user interface to display the set of responses, the set of inquiries, and the first subset of the user data.
